(19) United States
(12) Patent Application Publication
(10) Pub. No.: US 2003/0215046 A1
(43) Pub. Date: Nov. 20, 2003

(54) Pressure generating structure

(76) Inventor: Jason L. Hornkohl, Knoxville, TN (US)

Correspondence Address: LUEDEKA, NEELY & GRAHAM, P.C., P O BOX 1871, KNOXVILLE, TN, 37901, US

(21) Appl. No.: 10/147,739

(22) Filed: May 16, 2002

(51) Int. Cl. G21J 1/00; G21B 1/00

(52) U.S. Cl. 376/100

(57) ABSTRACT

A method and apparatus for forming a high pressure zone that can initiate a fusion reaction are provided by the present invention. In accordance with the preferred embodiments, a superheated phase bubble is imploded in a reaction chamber to produce a high pressure region and initiate the fusion reaction. The reaction chamber has sloped edges that focus opposing shock waves created by the imploding phase bubble toward a high pressure reacting region. The liquid is filled with deuterium, tritium, uranium, unstable isotopes, and/or other materials that are susceptible to nuclear or chemical reactions at high pressures. The resulting reactions can be used for countless applications.

### FIELD OF THE INVENTION

The present invention relates generally to creating high pressure regions that are useful for a variety of applications. More particularly, the present invention relates to the use of imploding bubbles to create a high pressure region that can be used to generate fusion reactions, create large molecules or split molecules and other particles.

### BACKGROUND OF THE INVENTION

People have been searching for the secret of Fusion Power for over 50 years. The utility of such a source of power is self-evident. It is known that very high pressures and temperatures are necessary to create a fusion reaction. The type of reactions created in the past were typically chain type reactions that produced extremely large amounts of energy. These fusion reactions produced so much energy that they were only useful for bombs as they would destroy any type of vessel made to contain them. Alternatively, in sonoluminescence experiments, the energy produced was so low that its existence was in doubt or it was only useful in experimentation. Fusion power could be based on deuterium and it is well known that deuterium can be found in water.

### SUMMARY OF THE INVENTION

Shaped charges are used to influence the direction and nature of an explosion. By shaping the explosive into a hollowed-out cone shape, a high-pressure concentrated shock wave is created that is centered in the cone and directed away from the apex of the cone. This directed shock wave can be used to tunnel through the armor of a tank or create a high pressure region in which the nuclear material undergoes fusion or fission. More particularly, opposing jets of high pressure gas shock waves can be directed to collide and create a relatively small area of extremely high pressure. The explosives can be shaped to form practically any shape of shock wave desired. For example, bent angle explosive charges, in the form of a triangle missing the base leg, create a longitudinal shock wave that may be used to cut through steel beams when demolishing buildings or blasting open doors. In an explosion of a hollow sphere, a shock wave is created that implodes on the center and creates a high pressure zone. An outward explosion accompanies this inner implosion. Unfortunately, an outward explosion accompanies the inward, implosion necessary to establish the pressures for fusion. This outward explosion is so strong that it destroys anything used to contain it. To avoid this problem, in accordance with preferred embodiments of the present invention, an implosion is created without a concurrent explosion and a fusion reaction is created that is so small that it does not produce a large explosion.

Ink jet printers are extremely complex modem products that eject small drops of ink to create an image. They are not nuclear powered devices. Basically, one type of ink jet printer functions by vaporizing a small drop of ink to create a relatively high pressure zone that ejects a drop of ink. It is the extremely small size and high speed of operation that make these devices amazing. They can produce very high resolution images consisting of millions of tiny ink spots at high speeds. The bubble of exploding ink used to eject the drop of ink has a very short life that is accompanied by a violent explosion of applied power.

Fusion reactions caused by vibrating bubbles produce sonoluminescence. However, the number of particles that have enough kinetic energy to overcome their nuclear forces during a collision is extremely small. The present invention is directed toward recognizing the factors that are controlling this reaction and improving the efficiency of the reactions to the point that they are capable of producing larger quantities of power.

The following references were considered when drafting the description of the invention herein and are hereby incorporated into the disclosure of this patent by reference. Copies are contained in the prosecution history of the application that resulted in the grant of this patent.

U.S. Pat. Nos. 6,350,016; 6,331,043; 6,267,468; 6,206,508; 6,131,518; 6,126,260, 6,126,269; 6,109,735; 6,035,897; 5,969,207; 5,795,460; 5,734,398; 5,086,974; 4,149,266

Effects of ionization in single-bubble sonoluminecsence, Physical Review E, Volume 65, 041201, Mar. 15, 2002.

Fusion-in-a bubble sparks controversy, Physics Web, Mar. 5, 2002.

Sound waves size up sonoluminescence, Physics Web, Feb. 5, 2002.

Boosting Sonoluminescence with a High-Intensity Ultrasonic Pulse Focused on the Bubble by an Adaptive Array, Physical Review Letters, Volume 88, Number 7, Feb. 18, 2002.

Effect of Volatile Solutes on Sonoluminescence, Journal of Chemical Physics, Volume 116, Number 7, Feb. 15, 2002.

Temperature in Multibubble Sonoluminescence, Journal of Chemical Physics, Volume 115, Number 7, Aug. 15, 2001.

Sonoluminescence and the Prospects for table-Top Micro-Thermonuclear Fusion, Lawrence Livermore National Laboratory.

Tabletop Fusion Report Elicits Mixed Reaction, Washington Post, Mar. 5, 2002, Page A01.

Among other things, the present invention takes advantage of two concepts that are in completely unrelated fields. First, a rapidly collapsing bubble in a super heated liquid produces relatively small areas of extremely high pressures. For example, a bubble produced in an ink jet printer results when a burst of energy in the form of an electrical pulse is sent to a resistor that superheats and vaporizes a small portion of the ink thereby forming a vaporized bubble that ejects a drop of ink from the nozzle. When the electrical pulse is over, the vapor in the bubble rapidly returns to the liquid state and collapses onto itself and the surface of the firing resistor. The force of this bubble collapsing is strong enough to pit the surface of a layer of protective material that is used for the very purpose of preventing this damage. The shock wave created is a relatively flat shock wave that collapses onto the surface of the resistor. The effects of this collapse are sometimes referred to as cavitation damage or pitting. The cavitation or bubble collapse of the preferred embodiments of the present invention are more properly referred to as a bubble implosion. This bubble implosion creates pressures that have pitted diamond surfaces materials with indention pressures in the gigapascals even when the bubble implosion shock wave was not focused. Furthermore, the temperatures, densities and pressures created by the vibrating bubbles in sonoluminescence are strong enough to initiate a fusion reaction that releases neutrons and tritium. In accordance with this invention, localized pressure zones are created in imploding bubbles in which the pressure is high enough for fusion. The low unobservable energy output of sonoluminesence is due to the fact that the prior art is utilizing an unfocused bubble implosion and they are creating it in the wrong type of material.

A preferred embodiment of the present invention initiates a nuclear or molecular reaction by producing and imploding a bubble of superheated heavy water in an extremely short amount of time. The bubble is contained within a partially enclosed chamber that creates a collapse zone. The preferred embodiments improve upon the prior art by rapidly and completely focusing a collapsing bubble in a collapse zone in a manner that creates the higher pressures needed for more robust nuclear reactions to occur. The embodiments utilize the concept of a shaped charge to focus the bubbles' implosion into the collapse zone. Shock waves created in a bubble implosion in a superheated liquid are shaped like the shockwaves created by explosives to provide an extremely small high-pressure zone for initiating a power producing fusion or fission reactions or creating molecules in high pressure environments. While explosives blow outward to create an inner high pressure region, the bubbles of the present invention implode upon themselves after expanding as the material in the bubble changes from the gas to liquid state.

### BRIEF DESCRIPTION OF THE DRAWINGS

FIG. 1 is a diagram of a preferred embodiment of the present invention having sloped edges for directing a bubble implosion;

FIG. 2 shows the preferred embodiment of FIG. 2 with a bubble expanded to its full extent.

FIG. 3 is a diagram illustrating the principles of bubble implosion utilized by the embodiments of the present invention;

FIG. 4 is a diagram of an embodiment of the present invention that utilizes contoured heating surfaces to influence the bubble implosion;

FIG. 5 is a diagram of an embodiment of the present invention having a single heating element;

FIG. 6 is an embodiment of the present invention using a firing resistor; and

FIG. 7 is a flow chart of a method for initiating a fusion reaction in accordance with a preferred embodiment of the present invention.

### DETAILED DESCRIPTION

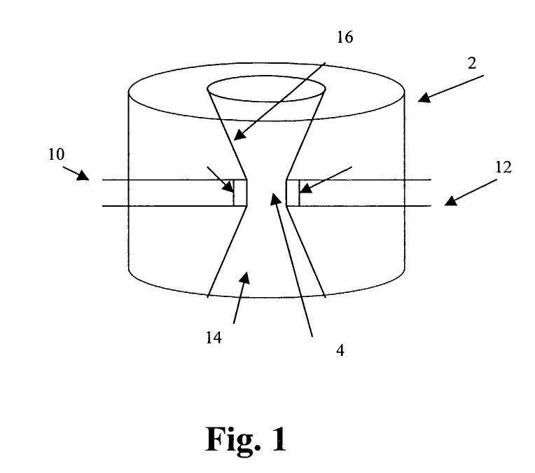

Referring now to FIG. 1, a diagram of a preferred embodiment of a pressure generator for initiating a fusion reaction is shown. The device consists of a reaction chamber 2 that has two opposing resistors 6 and 8 positioned on opposing sides of a collapse area 4. The reaction chamber 2 is preferably a small device with the resistors 6 and 8 having dimensions of several micrometers that creates a bubble of the same order of magnitude. The small size of the bubble created facilitates the superheating of the liquid and the corresponding rapid implosion of the bubble. The optimum size and characteristics of the firing resistors 6 and 8 depend upon the desired application and can be determined experimentally. It will be noted that embodiments of the present invention can completely implode bubbles of almost any size. As long as the ability to induce high pressures by rapidly collapsing a bubble formed from a superheated liquid exists, there is theoretically no limit to the size of the bubble that could be imploded with an embodiment of the present invention. Thus, while a smaller bubble is preferred due to the particularly rapid manner in which it collapses, bubbles having radius of a few millimeters or larger could easily be imploded. Bubbles having dimensions on the order of micrometers and nanometers are preferred and considered the best mode.

The bubbles are produced by the embodiment of FIG. 1 with a short duration pulse of energy and completely implode when the pulse is over. This complete implosion produces a much larger shockwave and corresponding higher pressure core than the vibrating bubbles utilized in prior single bubble and multi-bubble sonoluminescence experiments. However, even in the prior art vibrating bubbles of the sonoluminescence experiments, “Idealized theoretical extrapolations indicate that as the shock radius passes through 60 A the temperatures and densities are high enough for fusion”. Thus, contrary to what you might think, the pressures created in the vastly improved imploding bubbles of the present invention are, in localized areas, high enough to create fusion among susceptible atoms.

For illustrative purposes, assume the resistors 6 and 8 are constructed as those set forth in U.S. Pat. No. 5,734,398 which is hereby incorporated by reference. The point is to have resistors that produce superheated water vapor bubble similar to what is referred to in the '378 patent as “fluctuation nucleation boiling”. The construction and timing of these types of resistors are also set forth in U.S. Pat. No. 6,126,260 which discusses the “pressure wave bombardments” caused by the collapsing bubbles and is also hereby incorporated by reference. When a short, high amplitude voltage pulse of electricity is sent to the firing resistors 6 and 8 from a pair of conductors 10 and 12, a portion of the fluid in contact with the resistors 6 and 8 is vaporized at its superheat limit for a brief period of time to create an expanding relatively high pressure zone of vaporized water in the collapse zone 4. The surface of the resistors 6 and 8 should be as smooth as possible as bubble nucleation occurs at defects in the surface and it is desirable to create regular shaped bubbles such that their implosion can be precisely controlled. The duration and amplitude of the electrical pulse are experimental parameters that depend upon the concentration and the nature of the material in the collapse zone 4, the pressure and temperature of the fluid filling the bubble production mechanism 2, the shape of the bubble production mechanism 2, and the desired reaction from the implosion. The construction of this type of resistor is well known and an exemplary pulse for activating such a resistor has a duration of 3 microseconds and a maximum voltage of 18 volts. It should be noted that this is a pioneering invention and a great deal of trial and error will be required by one skilled in the art of fusion reactions, a limited field indeed, to determine the precise parameters that produce the optimum results for any particular application. However, in view of this disclosure, one skilled in the art could construct the device of FIG. 1 without undue experimentation or effort.

In a most preferred embodiment, diamond-like-carbon is used to form the resistors 6 and 8 because it resists cavitation damage, transmits heat very efficiently and can be doped to form a resistor. In such an embodiment, the semi-conductor substrate 4 is a diamond-like-carbon layer that has been doped to provide the resistors 6 and 8. A low conductivity electrical path to the resistors can be formed using chemical or vapor deposition.

The reaction chamber is preferably filled with a liquid such as water that has the material that will be fused or fissioned dissolved in the water. In a most preferred embodiment the liquid is “heavy water”, i.e., water in which an increased portion of the hydrogen consists of the heavy hydrogen isotope deuterium. However, using a properly designed reactor, the present inventor believes the pressures produced may be sufficient to obtain small numbers of nuclear reactions with almost any element present. Deuterium or tritium are preferred because they are more susceptible to fusing than other isotopes. Alternatively, a solution of water having Uranium 238 dissolved in it could be used. The force of the collapse will cause a portion of the Uranium 238 atoms to collide and break apart thereby releasing atomic energy. Interestingly, if the concentration of Uranium atoms is low enough, a chain reaction will not be initiated, although some Uranium atoms may be split apart and release energy. However, if the concentration is high enough some Uranium 238 atoms will release neutrons that will result in additional nuclear reactions. As will be discussed in more detail below, the concentration of the radioactive material in the water solution will determine the output per cycle or power of the reactor.

The liquid is also preferably heated to its superheat limit when it receives the energy from the resistor. Forming the bubble from the material the liquid is made out of eliminates some of the mass exchange problems discussed in the Physical Review Letter, Volume 72, Number 9, Feb. 28, 1994. However, the present invention can be utilized with different elements and molecules dissolved in any vaporizable solution. A super limit bubble is achieved by applying a high voltage, short duration pulse to the resistor. This will cause a particularly violent explosion and subsequent implosion of the bubble. Superheating is a concept that involves heating a liquid above its boiling point without allowing it to vaporize. Providing the energy to the bubble in a rapid, concentrated manner is important to achieving this superheating. When the energy hits the liquid, the liquid in contact with the resistor is heated before it can vaporize. This superheated liquid violently vaporizes as the bubble forms. As the bubble expands, the molecules that make up the bubble are rapidly accelerated to their maximum bubble extension position. This momentum carries the molecules slightly past the position they would obtain if the bubble was in its steady state.

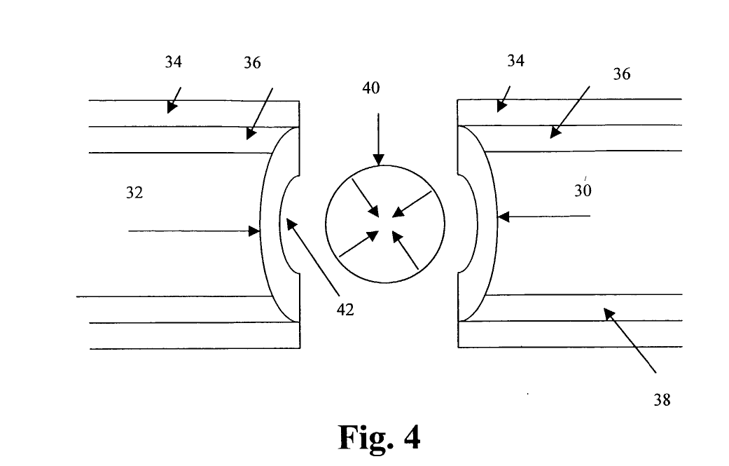

When the energy being supplied to the resistors 6 and 8 power is cut off, the high heat conduction rate of the material used to form the reaction chamber 2 and the cool water surrounding the bubble rapidly cause the water vapor at the edges of the bubble to loose energy and return to the liquid form. For all these reasons and more a phase boundary shock wave and a corresponding high density particle jet are created that rapidly move toward the center of the collapsing bubble. The collapse of the bubble is focused by the edges 16 of the reaction chamber 2 and the heat conductivity of the material from which the resistors 6 and 8 and reaction chamber 2 are constructed toward a center collapse area 4. Nuclear reactions between the tritium and deuterium atoms in the heavy water vapor occur in this high pressure collapse area 4. While they appear flat in FIG. 1, the resistors 6 and 8 of FIG. 1 can be shaped in three dimensions to further control the bubble implosion. An illustrative example is shown in FIG. 4 and discussed in more detail below.

At the point the power supply to the resistor is almost instantaneously cutoff, the energy that was feeding this molecular expansion is now gone. The energy necessary to maintain the vapor form of the bubble is rapidly drained from the bubble due to its small size. Thus, a state change from the liquid phase to the gas phase immediately begins to occur in the molecules at the edges of the bubble. This phase boundary races to the center of the bubble as it implodes. The surface tension energy in this phase boundary also races to the center of the bubble. During its progression to the center, this boundary wave reaches a boundary that marks the liquid volume of the molecules in the bubble. At this point, the bubble disappears and the remaining surface tension energy is imparted to the molecules. The molecules in the imploding bubble almost all have momentum directed toward the center of the imploding bubble. When the bubble reaches its liquid volume, the momentum of the molecules smashes the molecules together in a volume that is slightly less than the molecules liquid steady state volume. An additional effect is created due to the density of the water molecules in the exploding bubble varying from a minimum at the center of the bubble to a maximum at an outer edge of the bubble. As a result of this asymmetric distribution, a relatively large number of molecules collapse upon a relatively small number of molecules. At this point immense pressures are created in the center of the bubble implosion. The more rapid the state change the greater the pressures created. Thus, forming the superheated bubble in a cold liquid will create a particularly violent implosion of the bubble. Thus, some embodiments of this invention utilize a cooled liquid. Moreover, a preferred embodiment utilizes water slightly above its freezing point to maximize the heat removal from the bubble's edges and increase the force of the implosion.

The liquid utilized by the preferred embodiment of FIG. 1 is preferably pure water that has been degassed such that there are no stray molecules to interfere with the liquid/vapor boundary shock wave traveling toward the center of the imploding bubble. This minimizes the interference that different types of atoms and molecules might cause in the shock wave caused by the phase change of the water molecules. Furthermore, in a most preferred embodiment, where the bubble is a heavy water vapor bubble in liquid heavy water as opposed to a gas bubble such as argon in water, the material in the water bubble does not have to be absorbed by the collapsing water and the shock wave is allowed to rapidly perpetuate to its destruction point. This absorption can undesirably slow the progress of the boundary shock wave and decrease the pressures obtained. Thus, by utilizing a water vapor bubble in water vapor an extremely powerful and well shaped shock wave and corresponding high pressure zone can be created in such a preferred embodiment. Although water is preferred, the compression effect could be achieved with any vaporizable fluid. Furthermore, materials can be dissolved in the water to form solutions that are imploded thereby subjecting a small portion of the dissolved material to very high pressures. A number of useful materials such as tritium could be produced is such a high pressure region.

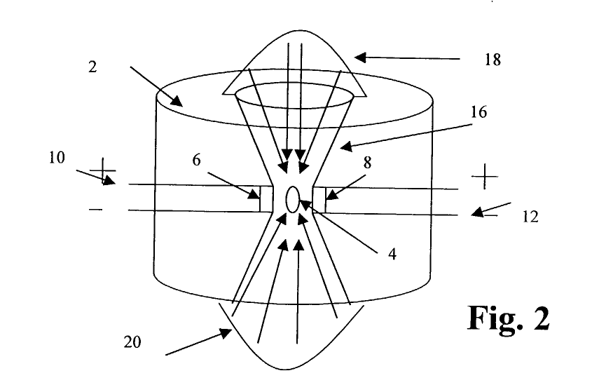

As discussed above, the fusion reaction is initiated by applying a pulse of energy to the two resistors. This pulse of energy causes a portion of the heavy water in the chamber to be vaporized into a bubble that extends out both sides of the chamber as illustrated in FIG. 2. The electrical pulse preferably has a high magnitude and a short duration. For exemplary purposes, assume the pulse has a peak voltage of 18 volts and a pulse duration of 3 microseconds.

The application of such an electrical pulse causes the bubble to reach its maximum expansion in about 7 to 8 microseconds. An exemplary maximum bubble expansion is shown in FIG. 2. FIG. 2 shows the heavy water vapor bubble at its maximum extent 16. As the bubble expands from the collapse zone 4 to its maximum extent 16, the pressure in the chamber begins to increase and resist the bubbles expansion. Furthermore, the rapid expansion is resisted by the water surrounding the expanding bubble. The density of the water particles in the expanding bubble is symmetrically distributed such that it is lowest near the surface of the resistor and increases toward the bubbles outer surface. Thus, when the bubble collapses, a relatively large number of particles in the outer portion of the bubble collapse upon a relatively small number of particles in the center of the bubble. However, when utilizing a material such as Uranium dissolved in the liquid a small portion of the heavy Uranium will be left behind by the water phase change boundary wave. This Uranium will be slammed together when the bubble collapses. The energy coming from the firing resistor is preferably abruptly cut off and the firing resistor is made of, or coated with, a material that rapidly absorbs or transmits heat to and from the liquid. The high heat conductivity of the resistor and quick termination of the firing pulse encourages the water vapor in the bubble next to the resistor to quickly change to the liquid state and, thus, directs the bubbles collapse away from the firing resistors surface.

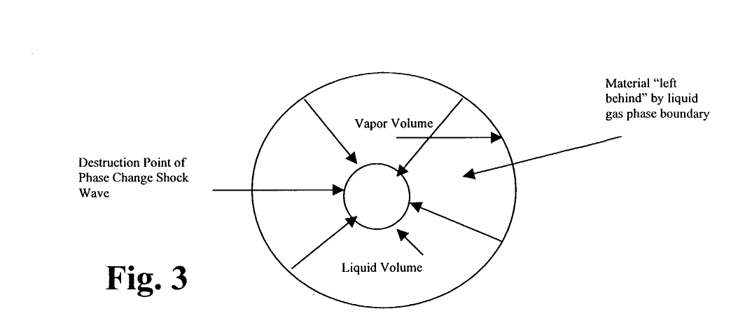

Once the electrical pulse is over, the vapor in the bubble will rapidly loose energy and begin to return to its liquid state causing the bubble to collapse or implode towards its liquid volume as illustrated in FIG. 3. This bubble collapse may occur in the span of a few microseconds. As the bubble implodes, a shock wave of matter is created that is directed toward the center of the reaction chamber from both ends of the reaction chamber. These directed shock waves concentrate the pressure into jets of material that collide with each other in the center of the reaction chamber creating a small zone of immense pressure. The actual pressure distribution in this zone is chaotic and the particles in the zone all have different kinetic energies. Any attempt to measure the highest pressure in this zone will by definition represent some type of average of the kinetic energy of the particles in the area chosen. However, some of the particles in this zone obtain the kinetic energy necessary to initiate a nuclear reaction. Thus, it is in this zone that the pressures are high enough to overcome the nuclear forces in the atoms of the nuclear material dissolved or incorporated into the water. Thus, a nuclear reaction occurs at the center of the Hornkohlian reaction chamber as the bubble implodes.

Once the nuclear reaction occurs, a preferred embodiment of the present invention the device will operate in one of four modes. In the first mode, the type and concentration of the material in the reaction chamber and the force of the directed shock waves are too low to create a large nuclear reaction and corresponding release of energy. Thus, in such a situation, no reaction at all may be observed. Alternatively, small flashes of light and radioactive materials will be observed in a similar fashion to those observed in sonoluminescence experiments. In this mode, the present invention could be used to create a light bulb by utilizing the sonoluminescent effect created by repeated firings. To operate in this mode, the device must be constantly supplied with new pulses of energy to continue producing the flashes of light. The reactor could be also be used in this mode to experiment with the concepts involved in its operation or produce various nuclear and non-nuclear materials. The particular materials produced would depend upon the precise conditions created in the reactor and the materials placed in the chamber. It will be obvious to one skilled in this limited art that this is a pioneering invention and a great deal of different materials and conditions could be utilized in accordance with this invention.

In the second mode, the resulting explosion from the release of nuclear energy creates just enough energy to vaporize a portion of the liquid roughly equal to the portion of liquid vaporized by the pulse of energy sent to initiate the bubble implosion. In this steady state situation, a second bubble is formed due to the release of atomic energy which again collapses and creates another nuclear reaction. Thus, in the second mode, the device will begin to oscillate without any further energy input until the energy output of the nuclear reaction is insufficient to cause the formation of a sufficient bubble to initiate another reaction. Operating in this mode the device could be used to heat water to produce a vapor pressure that could be drained off to produce steam and thereby fusion power for any number of applications.

In a third mode, the nuclear reaction creates enough energy to produce a bubble that is much larger than that created by the initial pulse of energy. This increased energy results in a long lasting bubble of steam that releases from the chamber and floats to the surface of the liquid. This steam bubble could be used to power a steam engine. However, when the bubble floats away without imploding, a chaotic situation is created with smaller bubbles imploding in different locations, possibly initiating new releases of energy or damaging the device. Alternatively, a new pulse of energy may need to be applied to initiate the next explosion. In such a situation, the firing of the resistors will function in a way that is analogous to a spark plug.

In one final mode, the concentration of the material to be reacted and the pressure created by the shaped bubble implosion are so high that an explosion is created whereby the device is destroyed. To avoid damage to the surface of the atomic reactor, a preferred embodiment of the present invention is designed to maximize the distance between the center of the implosion and the walls of the device.

The force of the bubble implosion is created by a number of effects. As the water changes from the liquid phase to the gaseous phase, a phase boundary shock wave is created that travels toward the center of a spherical bubble. For example, referring to FIG. 3, consider a water vapor bubble having a diameter of 1 micrometer. Such a water vapor bubble has a certain number of water molecules in the vapor state, n, and a vapor volume, v₁. When the vapor bubble collapses, its number of molecules will remain constant while its volume will change from its vapor volume v₁, to its liquid volume v₂. The vapor volume is considerably larger than the liquid volume. Thus, when the state change occurs in a bubble having a spherical form, the molecules rush toward the center of the bubble's previous volume to form a liquid droplet having the liquid volume. Energy is released in the state change from a vapor to a liquid. This energy partially propels the molecules in the imploding bubble from their vapor location to their liquid location. Energy is also provided by the pressure of the water surrounding the vapor bubble collapsing on the imploding bubble.

In addition to the above described effects, a surface tension shock wave is created in the phase bubble as the surface tension field having an area equal to the surface of the vapor volume sphere is reduced to a surface tension field that disappears as the molecules in the bubbles reach their vapor volume position. This surface tension energy is also imparted to the molecules in the bubble. Moreover, the energy is departed to the molecules in an uneven fashion as the bubble implodes. This is partly due to the fact that the area of the surface tension field is decreasing as the square of the rate of the speed of the phase shock wave as its approaches it destruction point. The destruction point occurs when the volume of the bubble reaches its liquid volume. This is shown in FIG. 3. At this point there is no surface tension field remaining and the energy in the phase shock wave consisting of the liquid/gas phase boundary and the accompanying surface tension field is imparted to the molecules in the liquid bubble volume in a burst.

When the bubble collapses, some molecules will receive more kinetic energy than other molecules. As previously discussed, one way to increase the number of molecules that will receive enough kinetic energy to initiate a nuclear reaction in the imploding bubble is to shape the implosion in the same way explosions are shaped to increase the maximum pressure in the shaped charges used to initiate nuclear explosions and pierce armor. In a most preferred embodiment of the present invention, a sloped edge is utilized to focus the force of the imploding bubble into a small area as shown in FIG. 1. Alternatively, the firing resistors may be shaped like the hollowed out bottom forth of a sphere as shown in FIG. 4 and discussed in more detail below. Furthermore, in preferred embodiments of the present invention opposing shock waves are created that crash together in a minimized area. The idea is to focus the force of the implosion on a single point. However, if the shock wave is directed toward the energy providing object that initiates the bubble, the energy providing object may be destroyed by the shockwave or the resulting nuclear reaction. Thus, the shock waves are preferably focused at an area away from the firing resistor. The unfocused force of the collapse is strong enough to pit a diamond surface.

As a further example of the present invention, consider the embodiment of FIG. 4. In this embodiment the resistors 30 and 32 have a hollowed-out quarter sphere shape 42 that is designed to produce a spherical high pressure zone 40 in the center of the device. The contoured shape of the resistor influences the shape of the bubble implosion. This is electrical conductors 36 and 38 provide a pulse of electricity to opposite ends of the resistors 30 and 32. An isolation layer 34 protects the conductors from the liquid in the compression zone 40. By constructing the surface of the firing resistors 30 and 32 out of a material that has a high heat conductivity, the edges of the imploding bubble can be made to pull away from the edges of the firing resistors 30 and 32. Thus, the high pressure zone 40 occurs away from the edge of the device in a region that is exposed to the liquid surrounding the reactor. This minimizes damage to the resistors 30 and 32 and assists in producing a rapidly collapsing bubble. In other embodiments of the present invention, a plurality of resistors in a plurality of locations may be used to shape the bubble in almost any form desired.

An approximation of the energy imparted to the molecules to move them from their vapor position to their liquid position can be calculated by measuring the time required for the bubble to implode and the distance between their starting position and their stopping position using standard physics. Thus, it can be seen that a great deal of kinetic energy is being provided to the water molecules in the imploding bubble and it is being provided in an unequal fashion. Thus, in certain circumstances some molecules will receive an amount of kinetic energy sufficient to initiate a fission or fusion reaction in the collapsing bubble.

Fusion reactions are occurring in collapsing bubbles. The brief flashes of light illustrated in the sonoluminescence of fluids subjected to shock waves are examples of this effect. However, the pressure created by the bubbles created in these experiments is not strong enough to create a fusion or fission reaction in the vast majority of particles in the fluid. Thus, only miniscule releases of energy occur which are witnessed as flashes of light. In order to create a useful device, the shock wave of the collapsing bubble and the assortment of elements in the fluid must be properly manipulated.

One way to increase the number of molecules in the bubble that acquire the kinetic energy required to overcome their nuclear forces is to use molecules in the bubble that are unstable to begin with. As previously discussed, deuterium or tritium molecules may be used as the hydrogen in the water molecules that form the imploding bubble. When the bubble implodes, a portion of the molecules will acquire the kinetic energy necessary to initiate a nuclear reaction. This is particularly true at the destruction point of the phase boundary wave where a large amount of energy was released in a very small amount of time. Also, the higher the concentration of the deuterium, the more likely such an event is to occur. Thus, by controlling the concentration of the deuterium in the imploding bubble, we can control the amount of energy released in the resulting nuclear explosion. Alternatively, uranium 238 molecules can be dissolved in the liquid solution. When the bubble collapses, a portion of the uranium 238 molecules will obtain the required kinetic energy when they collide in the imploding bubble thereby initiating a nuclear reaction.

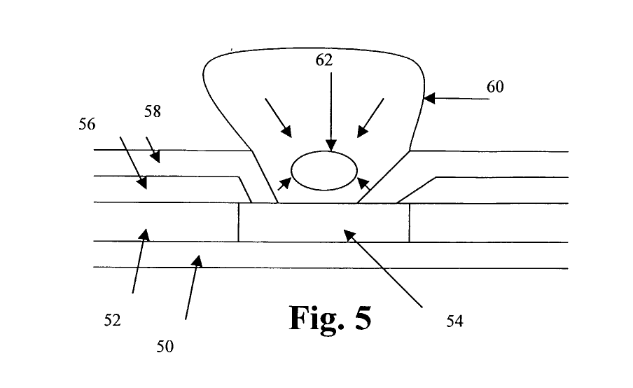

Referring now to FIG. 5 a single heating element 54 embodiment of the present invention is shown. The heating element 54 is constructed on a semiconductor substrate by using sputtering, chemical or vapor deposition, etching or other means to form a resistor 54 in a layer of material 52. Conductive paths 56 are then formed to provide electricity to the resistor 54. Finally, a shaping layer 58 is formed to shape the implosion of the bubble. The shaping layer 58 achieves this result in two different ways. First, the heat conductivity of the material of the layer 58 influences the rate at which heat is removed from the portion of the bubble in contact with the shaping layer 58 once the pulse of electricity is over. Secondly, the sloped edge of the shaping layer 58 in the region of the high pressure zone 62 focuses the implosion of the bubble toward the high pressure zone.

Consider the embodiment of FIG. 5 when a bubble is produced. The bubble will rapidly expand toward its maximum extent 60. Then, when the power is removed, the bubble will begin imploding from its maximum extent 60 where the water vapor is in contact with liquid water toward its liquid volume in the high pressure zone 62. The high heat conductivity of the shaping layer 58 will cause the bubble to collapse away from the shaping layer 58, however, the outer bubble boundary will collapse much quicker than the bubble boundary created by the shaping layer 58 and the resistive surface 54. Thus, a shaped shockwave from the outer bubble boundary 60 will collide with a shockwave rising off of the shaping layer 58 and resistor 54 surface in the high pressure zone 62. It is in this region that the extremely high pressures of the present invention are created.

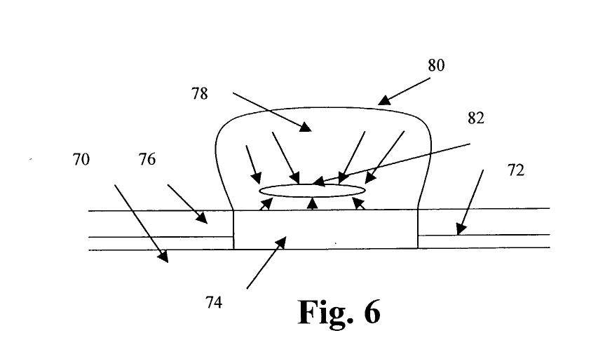

In FIG. 6 an alternative embodiment of the present invention based upon a standard firing resistor 74 is shown. The resistor 74 is constructed on a semi-conductor substrate 70 and supplied by conductive traces 72 covered by a protective layer 76. When a bubble 78 is created it expands to its maximum extent 80 and collapses into a high pressure region 82. The flat nature of the resistor 74 results in an elliptical high pressure zone 82 that is less focused than that of FIG. 1. However, by cooling the water that is to be superheated and enriching the concentration of tritium atoms in the water, a nuclear reaction can be made to occur. Thus, the present invention can be practiced with materials that are readily available.

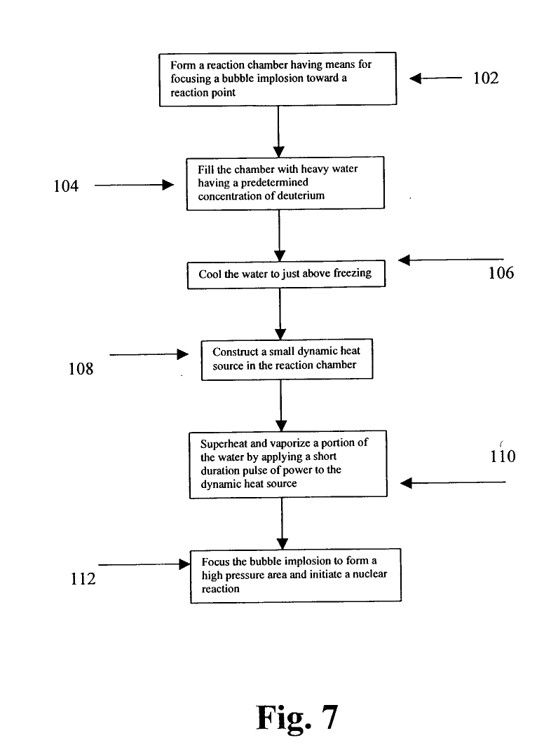

A preferred method of creating a fusion reaction is set forth in FIG. 7. In block 102, the method commences with the forming of a reaction chamber having means for focusing the bubble implosion toward a reaction point. The reaction chamber is then filled with heavy water having a predetermined concentration of deuterium as set forth in block 104. The heavy water is cooled in block 106. A small dynamic heat source is constructed in the reaction chamber as shown in block 108. The method then proceeds to block 110 where a portion of the water is vaporized by a applying a short duration pulse of power to the dynamic heat source. The method is completed by focusing the imploding bubble to form a high pressure area and initiate a nuclear reaction as shown in block 112.

The above discussed embodiments of the invention are exemplary only and not intended to limit the scope of the present invention. Many different materials could be used in a variety of different reactors constructed in accordance with the present invention. Furthermore, the present invention could be used in an infinite number of applications as the utility of fusion power is self evident. Therefore, the proper scope of the present invention is set forth in the claims below.

I claim:

1. A method of creating a nuclear reaction, the method comprising:
obtaining a volume of liquid;
placing the liquid in a reaction chamber;
superheating a portion of the liquid to create a phase bubble in the liquid; and
manipulating the implosion of the phase bubble to initiate a nuclear reaction.

2. The method of claim 1 further comprising cooling the liquid to just above its freezing point.

3. The method of claim 2 further comprising focusing the bubble implosion to create a reaction zone.

4. The method of claim 1 wherein the step of superheating a portion of the liquid further comprises constructing a resistive heating reaction surface in the reaction chamber.

5. The method of claim 1 wherein the reaction chamber is shaped to focus the phase bubble implosion.

6. The method of claim 4 wherein the heat conductivity of the material from which the reaction chamber is constructed is selected to focus the implosion of the phase bubble.

7. The method of claim 1 wherein the liquid is water containing an increased amount of deuterium and tritium.

8. A nuclear reactor that utilizes a phase bubble implosion to initiate a nuclear reaction.

9. The nuclear reactor of claim 8 wherein the phase bubble implosion is initiated in water.

10. The nuclear reactor of claim 9 wherein a material is dissolved in the water to manipulate effects of the bubble implosion.

11. The nuclear reactor of claim 9 wherein an elevated number of hydrogen atoms in the water are deuterium or tritium.

12. The nuclear reactor of claim 9 wherein the water contains a solution of fissionable elements.

13. The nuclear reactor of claim 8 wherein the bubble implosion is shaped by dissolving a material in the material used to create the phase bubble.

14. The nuclear reactor of claim 13 wherein the resistive heating element is positioned in a reaction chamber that focuses the bubble implosion.

15. An apparatus for producing a high pressure zone, said apparatus comprising:
a heating element for producing a superheated bubble in a liquid; and
a reaction chamber for focusing the implosion of the bubble into a high pressure zone.

16. The apparatus of claim 15 wherein the liquid is water and a material is dissolved in the water.

17. The apparatus of claim 15 wherein the liquid is pressurized.

18. The apparatus of claim 15 wherein the liquid is cooled.

19. The apparatus of claim 15 wherein the surface of the resistive heating element is contoured to shape the bubble implosion

20. The apparatus of claim 15 wherein the thermal conductivity of the material from which the heating element is constructed is selected to shape the bubble implosion
